(19) United States
(12) Patent Application Publication
(10) Pub. No.: US 2022/0214227 A1
(43) Pub. Date: Jul. 7, 2022

(54) TEMPERATURE DETECTION DEVICE, TEMPERATURE DETECTION SYSTEM, DISPLAY DEVICE, AND HEAD-UP DISPLAY

(71) Applicant: Japan Display Inc., Tokyo (JP)

(72) Inventor: Masashi TAKAHATA, Tokyo (JP)

(21) Appl. No.: 17/557,766

(22) Filed: Dec. 21, 2021

(30) Foreign Application Priority Data
Jan. 7, 2021 (JP) 2021-001717

(51) Int. Cl. G01K 7/16; G02B 27/01; G01K 1/02

(52) U.S. Cl. CPC G01K 7/16; G01K 1/026; G02B 27/0149

(57) ABSTRACT

A temperature detection device includes a plurality of temperature sensors each including a temperature detection resistor element provided in a temperature detection region, and a storage unit configured to store therein unique information for each of a plurality of the temperature detection resistor elements. The temperature detection resistor element is provided for each of a plurality of partial temperature detection regions in the temperature detection region, and an externally provided control device reads out the unique information stored in the storage unit and detects a temperature for each of the partial temperature detection regions in the temperature detection region based on the unique information and an output potential that is output from the temperature sensor.

### CROSS-REFERENCE TO RELATED APPLICATION

This application claims the benefit of priority from Japanese Patent Application No. 2021-001717 filed on Jan. 7, 2021, the entire contents of which are incorporated herein by reference.

### BACKGROUND

### 1. Technical Field

The present disclosure relates to a temperature detection device, a temperature detection system, a display device, and a head-up display.

### 2. Description of the Related Art

What-is-called head-up displays (HUD) that project an image onto a member having a light-transmitting property, such as glass, have been known.

The technique above describes that sunlight may be incident on a display device through an optical system. When the display device is exposed to the sunlight condensed by the optical system, the temperature of a place thereof exposed to the sunlight becomes high and the display device may be adversely affected. A temperature information acquisition method in which a temperature is specified on the basis of change in an electric resistance value of an electrode provided as a temperature detection element has been known.

When a temperature detection function is added to the display device simply, a circuit corresponding to a display output function and a circuit corresponding to the temperature detection function are separately provided and wiring is coupled to each of the circuits. A signal transmission path is also required between the circuit corresponding to the display output function and the circuit corresponding to the temperature detection function in order to control display in response to increase in temperature. Accordingly, the above-mentioned display device causes complication due to increase in the number of circuits and wiring lines and causes increase in cost of a wiring substrate.

The present disclosure has been made in view of the above-mentioned problem, and an object thereof is to provide a temperature detection device, a temperature detection system, a display device, and a head-up display capable of preventing increase in cost due to provision of a temperature detection function.

### SUMMARY

A temperature detection device according to an embodiment of the present disclosure includes a plurality of temperature sensors each including a temperature detection resistor element provided in a temperature detection region, and a storage unit configured to store therein unique information for each of a plurality of the temperature detection resistor elements. The temperature detection resistor element is provided for each of a plurality of partial temperature detection regions in the temperature detection region, and an externally provided control device reads out the unique information stored in the storage unit and detects a temperature for each of the partial temperature detection regions in the temperature detection region based on the unique information and an output potential that is output from the temperature sensor.

A temperature detection system according to an embodiment of the present disclosure includes a temperature detection device including a plurality of temperature sensors each including a temperature detection resistor element provided in a temperature detection region, and a storage unit configured to store therein unique information for each of a plurality of the temperature detection resistor elements, the temperature detection resistor element being provided in each of a plurality of partial temperature detection regions in the temperature detection region, and a control circuit configured to read out the unique information stored in the storage unit and detect a temperature for each of the partial temperature detection regions in the temperature detection region based on the unique information and an output potential that is output from the temperature sensor.

A display device according to an embodiment of the present disclosure includes a display panel configured to display an image, and the temperature detection device above. The temperature detection device is arranged so as to overlap with the display panel.

A head-up display according to an embodiment of the present disclosure includes a display panel configured to display an image, and a temperature detection device arranged so as to overlap with a display surface of the display panel. The temperature detection device includes a plurality of temperature sensors each including a temperature detection resistor element provided in a temperature detection region, and a storage unit configured to store therein unique information for each of a plurality of the temperature detection resistor elements, the temperature detection resistor element is provided for each of a plurality of partial temperature detection regions in the temperature detection region, and an externally provided control device reads out the unique information stored in the storage unit and detects a temperature for each of the partial temperature detection regions in the temperature detection region based on the unique information and an output potential that is output from the temperature sensor.

### BRIEF DESCRIPTION OF THE DRAWINGS

FIG. 1 is a descriptive view for schematically explaining a HUD device;

FIG. 2 is a schematic view illustrating the main configuration of a temperature detection device according to a first embodiment and a control device;

FIG. 3 is a configuration diagram of a temperature sensor of the temperature detection device according to the first embodiment;

FIG. 4 is a block diagram illustrating an example of the configuration of the control device for temperature detection in the temperature detection device according to the first embodiment;

FIG. 5 is a flowchart illustrating an example of temperature detection processing in the temperature detection device according to the first embodiment;

FIG. 6 is a diagram illustrating an example of pieces of unique information stored in a storage unit of the temperature detection device according to the first embodiment;

FIG. 7 is a flowchart illustrating an example of processing of deriving the pieces of unique information;

FIG. 8 is a plan view for explaining a positional relation between a display region and a temperature detection region in a display panel;

FIG. 9 is a schematic view illustrating the main configuration of a temperature detection device according to a second embodiment and the control device; and

FIG. 10 is a schematic view illustrating the main configuration of a temperature detection device according to a modification of the second embodiment and the control device.

### DETAILED DESCRIPTION

Modes for carrying out the present disclosure (embodiments) will be described in detail with reference to the drawings. Contents described in the following embodiments do not limit the present disclosure. Components described below include those that can be easily assumed by those skilled in the art and substantially the same components. Furthermore, the components described below can be appropriately combined. What is disclosed herein is merely an example, and it is needless to say that appropriate modifications within the gist of the disclosure at which those skilled in the art can easily arrive are encompassed in the scope of the present disclosure. In the drawings, widths, thicknesses, shapes, and the like of the components can be schematically illustrated in comparison with actual modes for more clear explanation. They are however merely examples and do not limit interpretation of the present disclosure. In the present specification and the drawings, the same reference numerals denote components similar to those described before with reference to the drawing that has been already referred, and detail explanation thereof can be appropriately omitted.

### First Embodiment

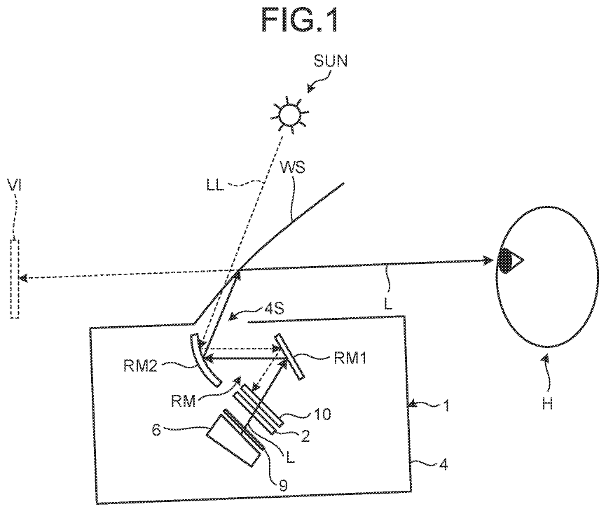

FIG. 1 is a descriptive view for schematically explaining a HUD device 1. The HUD device 1 includes a light source unit 6, a diffusion plate 9, a display panel 2, and an optical system RM configured to enlarge an image from the display panel 2 and project the image onto a projection plate WS.

A housing 4 accommodates therein the light source unit 6 functioning as a light source device, the display panel 2 configured to output the image using light L from the light source unit 6 as a light source, the diffusion plate 9 provided between the display panel 2 and the light source unit 6, the optical system RM, and a temperature detection device 10.

The light L emitted from the light source unit 6 is diffused by the diffusion plate 9 and reaches the display panel 2, so that a part or all of the light L passes through the display panel 2 to be light of the image. In the HUD device 1 in the first embodiment, the optical system RM including a mirror member RM1 and a mirror member RM2 guides the light L after passing through the display panel 2 to the projection plate WS. The mirror member RM1 is a plane mirror, and the mirror member RM2 is a concave mirror. The mirror member RM1 may be a concave mirror. The mirror member RM2 may be a plane mirror. The optical system RM is not limited thereto, and the optical system RM may include one mirror member or equal to or more than three mirror members.

Light of the image that has passed through the optical system RM is reflected by the projection plate WS and reaches a user H to be recognized as an image VI in a visual field of the user H. That is to say, the HUD device 1 in the first embodiment functions as a display system configured to project the image onto the projection plate WS. It is sufficient that the projection plate WS is a member having a light-transmitting property and located on the visual line of the user H. The projection plate WS is, for example, a windscreen, a windshield, or a light-transmitting plate member called a combiner of a vehicle, the combiner being provided as a separate member from the windscreen.

As illustrated in FIG. 1, sunlight LL may be incident on an opening 4S of the housing 4 depending on a relative position of the sun SUN in the HUD device 1. The sunlight LL is guided by the optical system RM and is condensed toward the display panel 2 in some cases. The condensed sunlight possibly causes abnormality in the display panel 2 during operation. It is therefore desired that a partial temperature state of a display region is detected.

In response to the desire, the temperature detection device 10 is provided on the mirror member RM1 side with respect to the display panel 2 in the first embodiment. As illustrated in FIG. 1, the temperature detection device 10 is arranged so as to receive light guided by the optical system RM and condensed toward the display panel 2 on the mirror member RM1 side of the display panel 2. The temperature detection device 10 is provided to be capable of detecting a surface temperature of the temperature detection device 10. Accordingly, in the embodiment, the temperature detection device 10 can detect temperature change caused by the light guided by the optical system RM and condensed toward the display panel 2. Deterioration in display output quality due to the display panel 2 can be prevented by controlling operations of the display panel 2 and the light source unit 6 on the basis of the temperature change generated in the temperature detection device 10, such as by preventing a high-temperature portion from being exposed to light from the light source unit 6, by turning off a display operation in the high-temperature portion, and so on.

The temperature detection device 10 may be separated from the display panel 2 or abut against or adhere to the display panel 2. The temperature detection device 10 may be provided integrally with the display panel 2.

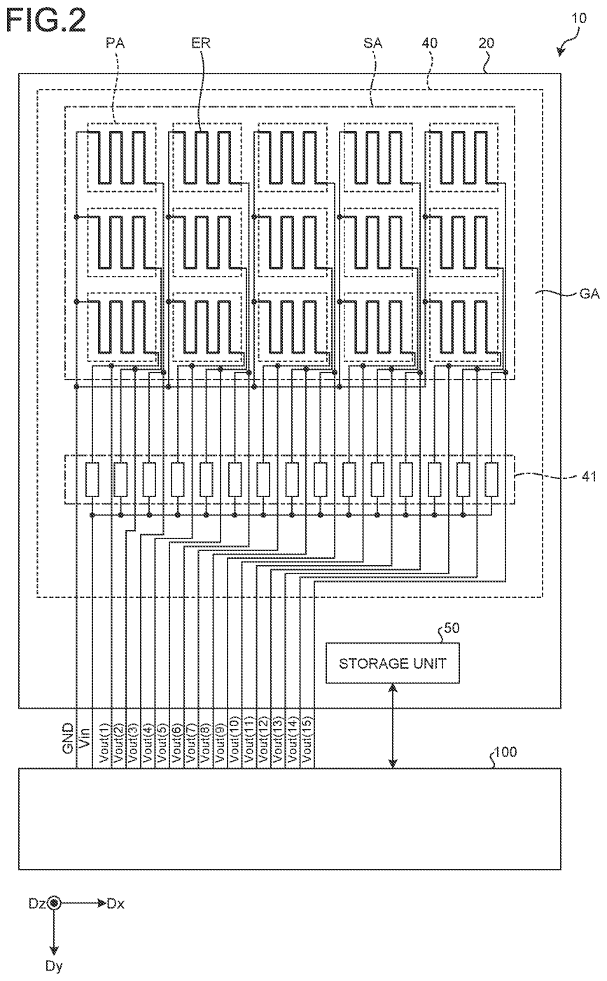

FIG. 2 is a schematic view illustrating the main configuration of the temperature detection device according to the first embodiment and a control device. As illustrated in FIG. 2, the temperature detection device 10 includes a sensor base member 20, a sensor unit 40, and a storage unit 50. The temperature detection device 10 is electrically coupled to a control device 100.

The sensor base member 20 has a temperature detection region SA and a peripheral region GA. The temperature detection region SA includes a plurality of partial temperature detection regions PA. The partial temperature detection regions PA are regions in which a plurality of temperature detection resistor elements ER included in the sensor unit 40 are respectively provided. FIG. 2 illustrates, as an example, 15 partial temperature detection regions PA in total with five partial temperature detection regions PA aligned in a first direction Dx and three partial temperature detection regions PA aligned in a second direction Dy. The number of partial temperature detection regions PA is however not limited thereto. For example, a configuration including 12 partial temperature detection regions PA in total with four partial temperature detection regions PA aligned in the first direction Dx and three partial temperature detection regions PA aligned in the second direction Dy can also be employed.

The first direction Dx is one direction in a plane parallel with the sensor base member 20. The second direction Dy is one direction in the plane parallel with the sensor base member 20 and is a direction orthogonal to the first direction Dx. The second direction Dy may non-orthogonally intersect the first direction Dx. A third direction Dz is a direction orthogonal to the first direction Dx and the second direction Dy, and is a direction normal to the sensor base member 20.

Each temperature detection resistor element ER is an electric resistor using compound (metal compound) containing an alloy or metal, or metal as a material. The resistor element ER may be a multilayered body formed by stacking a plurality of types of materials falling under at least one of the metal, alloy, and metal compound. An expression “alloy or the like” in explanation of the first embodiment indicates a material capable of being employed as a composition of the resistor element ER. In the example illustrated in FIG. 2, each of the temperature detection resistor elements ER has such shape that a plurality of L-shaped wiring lines the long sides of which are along the second direction Dy are coupled in the first direction Dx. With such a shape, the mode of each temperature detection resistor element ER is provided by coupling the L-shaped wiring lines such that the short sides of the two L-shaped wiring lines adjacent to each other in the first direction Dx are alternately arranged in the second direction Dy.

The peripheral region GA is a region between the outer periphery of the temperature detection region SA and end portions of the sensor base member 20 and is a region in which no temperature detection resistor element ER is provided. A plurality of reference resistor elements 41 and the storage unit 50 are provided in the peripheral region GA. The temperature detection resistor elements ER provided in the respective partial temperature detection regions PA and the reference resistor elements 41 provided in the peripheral region GA configure a temperature sensor, which will be described later.

The storage unit 50 is a rewritable non-volatile memory such as a flash memory. The storage unit 50 stores therein pieces of unique information for the respective temperature detection resistor elements ER provided in the partial temperature detection regions PA. The pieces of unique information that are stored in the storage unit 50 are, to be specific, unique values indicating electric characteristics differing for the respective temperature detection resistor elements ER. Resistance values of the temperature detection resistor elements ER under a constant temperature environment may be different due to variations, and change rates of the resistance values thereof for temperature change may be different. Accordingly, when the temperature detection device 10 of the present disclosure detects the temperatures of the partial temperature detection regions PA in the temperature detection region SA, it needs to compensate for variations of the electric characteristics differing for the respective temperature detection resistor elements ER.

The control device 100 supplies control signals to the sensor unit 40 and the storage unit 50 to control detection operations of the temperature detection device 10. The control device 100 may have a mode that supplies control signals to the display panel 2 and the light source unit 6 to control the display operations in the display panel 2 and lighting or non-lighting of the light source unit 6.

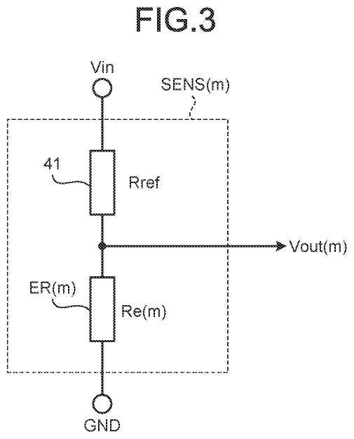

FIG. 3 is a configuration diagram of each temperature sensor of the temperature detection device according to the first embodiment. FIG. 3 exemplifies a temperature sensor SENS(m) corresponding to m (m is an integer of 1 to M) partial temperature detection region PA among M (M=15 in the example illustrated in FIG. 2) partial temperature detection regions PA.

As illustrated in FIG. 3, the temperature sensor SENS(m) of the temperature detection device 10 according to the first embodiment is configured by electrically coupling the reference resistor element 41 and the temperature detection resistor element ER(m) in series between an input potential Vin input from the control device 100 and a reference potential GND. The temperature sensor SENS(m) outputs an output potential Vout(m) based on a volume resistivity of the temperature detection resistor element ER(m). In other words, a potential at a coupling point between the temperature detection resistor element ER(m) and the reference resistor element 41 is output as the output potential Vout(m) of the temperature sensor SENS(m).

In the temperature sensor SENS(m), a current generated on the basis of the input potential Vin tries to flow to the reference potential GND. The flow of the current to the reference potential GND is however inhibited depending on the volume resistivity of the temperature detection resistor element ER(m), so that a current toward the control device 100 is generated. The current flowing toward the control device 100 generates the output potential Vout(m). That is to say, as the volume resistivity of the temperature detection resistor element ER(m) is higher, the output potential Vout(m) is increased.

Where a resistance value of the reference resistor element 41 is Rref and a resistance value of the temperature detection resistor element ER(m) is Re(m), the output potential Vout(m) of the temperature sensor SENS(m) is expressed by the following equation (1).

Vout(m)=[Re(m)/{Re(m)+Rref}]×Vin (1)

In this case, a temperature TPA(m) detected by the temperature sensor SENS(m) is expressed by the following equation (2).

TPA(m)=[Rref/{Vin/Vout(m))−1)}]×a(m)+b(m) (2)

In the above-mentioned equation (2), a first coefficient a(m) and a second coefficient b(m) are unique values for compensating for variations of the electric characteristics of the temperature detection resistor element ER(m) and are different for each temperature detection resistor element ER(m). Accordingly, when the control device 100 calculates the temperatures of the respective partial temperature detection regions PA that are detected by the corresponding temperature sensors SENS(m), it needs to apply the first coefficients a(m) and the second coefficients b(m) differing for the respective temperature detection resistor elements ER(m) of the temperature sensors SENS(m), in other words, for the respective output potentials Vout(m) that are output from the partial temperature detection regions PA.

In the present disclosure, the storage unit 50 stores therein the first coefficients a(m) and the second coefficients b(m) corresponding to the output potentials Vout(m) that are output from the respective temperature sensors SENS(m) as the pieces of unique information for the respective temperature detection resistor elements ER(m) provided in the corresponding partial temperature detection regions PA. The control device 100 accesses the storage unit 50 to read out the first coefficients a(m) and the second coefficients b(m) corresponding to the output potentials Vout(m) that are output from the respective temperature sensors SENS(m), and calculates the temperatures of the respective partial temperature detection regions PA in the temperature detection region SA. Hereinafter, the configuration for performing processing of calculating the temperatures of the respective partial temperature detection regions PA in the temperature detection region SA and the temperature calculation processing will be described.

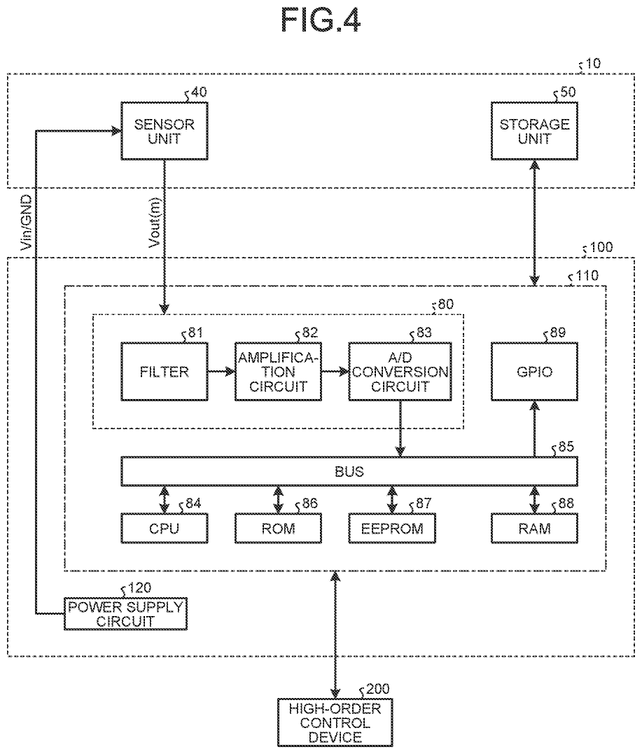

FIG. 4 is a block diagram illustrating an example of the configuration of the control device for temperature detection in the temperature detection device according to the first embodiment. As illustrated in FIG. 4, the control device 100 includes a control circuit 110 and a power supply circuit 120. The configuration provided by combining the temperature detection device 10 according to the first embodiment and the control circuit 110 corresponds to a “temperature detection system” in the present disclosure.

The control circuit 110 is configured by a temperature detection control IC packaged as a what-is-called one-chip integrated circuit (IC), for example. The control circuit 110 may have a mode that is configured by a plurality of ICs, for example.

The control circuit 110 includes a temperature detection circuit 80, a central processing unit (CPU) 84, a bus 85, a read only memory (ROM) 86, an electrically erasable programmable read only memory (EEPROM) 87, a random access memory (RAM) 88, and a general purpose input output (GPIO) 89. The temperature detection circuit 80 includes a filter 81, an amplification circuit 82, and an A/D conversion circuit 83.

The filter 81 is a filter circuit configured to remove noise from the output potentials Vout(m) that are output from the partial temperature detection regions PA of the temperature detection device 10. The amplification circuit 82 amplifies the output potentials provided by noise processing by the filter 81. The A/D conversion circuit 83 converts analog output potentials provided by amplification by the amplification circuit 82 into digital signals.

The CPU 84 of the control circuit 110 performs various pieces of arithmetic processing such as processing based on the digital signals generated by the A/D conversion circuit 83.

The bus 85 functions as a transmission path of various digital signals in the control circuit 110, and for example, it transmits the digital signals that are output from the A/D conversion circuit 83 to the CPU 84. The A/D conversion circuit 83, the CPU 84, the bus 85, the ROM 86, the EEPROM 87, the RAM 88, and the GPIO 89 are coupled to the bus 85.

The ROM 86 stores therein a computer program and the like in a non-rewritable manner. The computer program and the like indicate a software computer program that is read out in processing by the CPU 84 and data that is referred in execution of the software computer program. The EEPROM 87 stores therein the computer program and the like in a rewritable manner. The RAM 88 temporarily stores therein various pieces of date and parameters that are generated with execution processing of the computer program and the like by the CPU 84.

The GPIO 89 transmits signals to the outside in response to output from the CPU 84 and the like through the bus 85.

The power supply circuit 120 is a circuit configured to supply the input potential Vin to the sensor unit 40 of the temperature detection device 10. Potential difference between the input potential Vin and the reference potential GND is thereby applied to the temperature sensor SENS(m) illustrated in FIG. 3. The power supply circuit 120 supplies power supply to the storage unit 50 of the temperature detection device 10.

In the above-mentioned configuration, the control circuit 110 performs communication with the storage unit 50 of the temperature detection device 10 and an external high-order control device 200. The present disclosure is not limited by a protocol, an interface, and the like of communication that is performed with the storage unit 50 of the temperature detection device 10 and the external high-order control device 200.

Hereinafter, the temperature detection processing in the control device 100 using the temperature detection device 10 according to the first embodiment will be described.

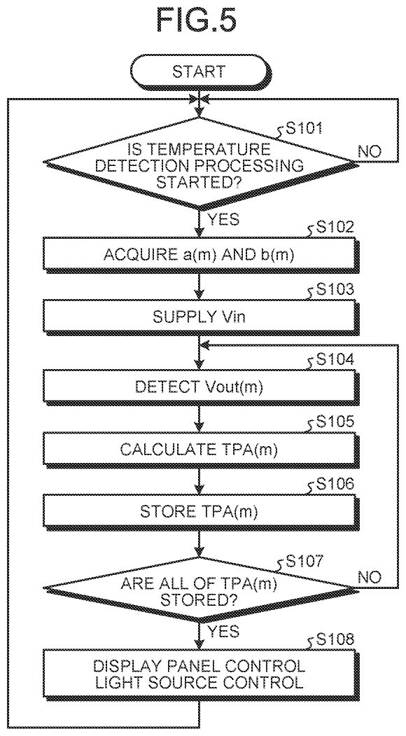

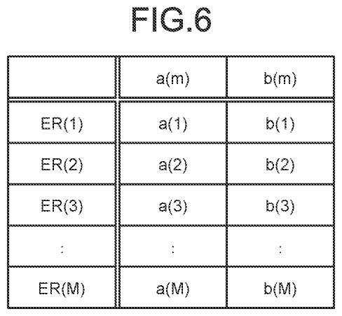

FIG. 5 is a flowchart illustrating an example of the temperature detection processing in the temperature detection device according to the first embodiment. FIG. 6 is a diagram illustrating an example of the pieces of unique information stored in the storage unit of the temperature detection device according to the first embodiment.

The storage unit 50 of the temperature detection device 10 stores therein the pieces of unique information illustrated in FIG. 6, for example, as a precondition of the temperature detection processing illustrated in FIG. 5. To be specific, as illustrated in FIG. 6, the storage unit 50 stores therein the first coefficients a(m) and the second coefficients b(m) that are used in the above-mentioned equation (2) as the pieces of unique information for the respective temperature detection resistor elements ER(m) provided in the corresponding partial temperature detection regions PA.

First, the control device 100 determines whether the temperature detection processing is started (step S101). When the temperature detection processing is not started (No at step S101), the control device 100 repeats the processing at step S101 until the temperature detection processing is started (Yes at step S101). The start of the temperature detection processing may be in a mode in which a temperature detection start instruction is input from the high-order control device 200 or in a mode in which the control device 100 includes a trigger (for example, a timer) of starting the temperature detection processing, for example. The temperature detection processing illustrated in FIG. 5 may have a mode that executes as interruption processing into various pieces of processing in the control device 100.

When the temperature detection processing is started (Yes at step S101), the pieces of unique information illustrated in FIG. 6, for example, are read out and acquired from the storage unit 50 of the temperature detection device 10 (step S102). The pieces of unique information read out from the storage unit 50 are temporarily stored in the RAM 88 of the control circuit 110, for example.

The power supply circuit 120 of the control device 100 supplies the input potential Vin to the sensor unit 40 of the temperature detection device 10 (step S103).

The control device 100 detects the output potential Vout(m) output from the sensor unit 40 of the temperature detection device 10 (step S104), calculates the temperature TPA(m) detected by the temperature sensor SENS(m) with the above-mentioned equation (2) using the pieces of unique information acquired from the storage unit 50 of the temperature detection device 10 for the output potential Vout(m) (step S105), and temporarily stores the calculated temperature TPA(m) in the RAM 88 of the control circuit 110, for example (step S106).

The control device 100 determines whether the temperatures TPA(m) corresponding to all of the partial temperature detection regions PA in the temperature detection region SA are stored (step S107). When the temperatures TPA(m) corresponding to all of the partial temperature detection regions PA in the temperature detection region SA are not stored (No at step S107), the control device 100 repeats the pieces of processing at step S104 to step S107 until the temperatures TPA(m) corresponding to all of the partial temperature detection regions PA in the temperature detection region SA are stored (Yes at step S107).

When the temperatures TPA(m) corresponding to all of the partial temperature detection regions PA in the temperature detection region SA are stored (Yes at step S107), the control device 100 performs predetermined control on the display panel 2 and the light source unit 6 using the temperatures TPA(m) corresponding to the partial temperature detection regions PA (step S108) and returns to the processing at step S101. As the predetermined control on the display panel 2, a mode in which any of a plurality of display control patterns is applied depending on the temperatures TPA(m) corresponding to the respective partial temperature detection regions PA may be employed. As the predetermined control on the light source unit 6, a mode in which any of a plurality of light source control patterns is applied depending on the temperatures TPA(m) corresponding to the respective partial temperature detection regions PA may be employed. The present disclosure is not limited by the modes of the control on the display panel 2 and the light source unit 6 depending on the temperatures TPA(m) corresponding to the partial temperature detection regions PA.

Next, a method of deriving the pieces of unique information for the respective temperature detection resistor elements ER(m) provided in the corresponding partial temperature detection regions PA, which are illustrated in FIG. 6, will be described. The pieces of unique information for the respective temperature detection resistor elements ER(m) provided in the corresponding partial temperature detection regions PA, that is, the first coefficients a(m) and the second coefficients b(m) that are used in the above-mentioned equation (2) are, for example, set in a process before shipping of the temperature detection device 10 according to the first embodiment and stored in the storage unit 50.

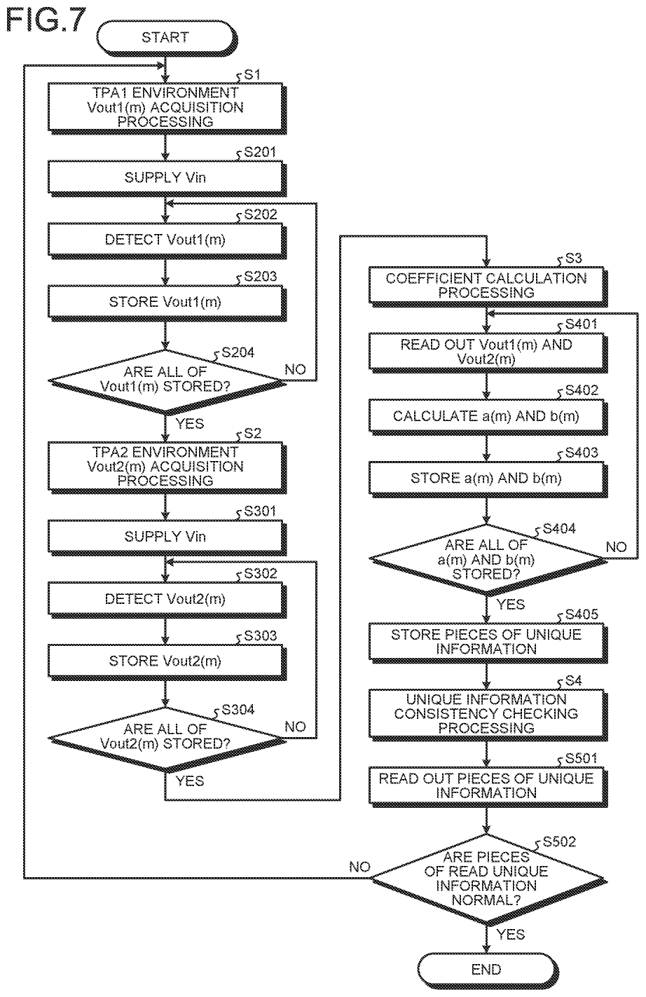

FIG. 7 is a flowchart illustrating an example of the processing of deriving the pieces of unique information.

A setting tool device is coupled to the temperature detection device 10 according to the first embodiment as a precondition of the processing of deriving the first coefficients a(m) and the second coefficients b(m) for the respective temperature detection resistor elements ER(m) as the pieces of unique information, which is illustrated in FIG. 7. The configuration of the setting tool device is similar to the configuration of the control device 100 illustrated in FIG. 4. Therefore, in the following description, the setting tool device is replaced with the control device 100, and a mode in which the control device 100 performs the processing of deriving the pieces of unique information illustrated in FIG. 6 is described.

The processing of deriving the pieces of unique information, which is illustrated in FIG. 7, is performed as follows. That is, each first coefficient a(m) and each second coefficient b(m) in the above-mentioned equation (2) are handled as variables, the first coefficient a(m) and the second coefficient b(m) corresponding to each temperature detection resistor element ER(m) are calculated using the following equation (3) and the following equation (4), and the first coefficient a(m) and the second coefficient b(m) that have been calculated are stored in the storage unit 50 as a part of the pieces of unique information illustrated in FIG. 6. In the following equation (3), an output potential Vout1(m) that is output from each partial temperature detection region PA of the temperature detection device 10 under a first temperature TPA1 environment (to be specific, for example, in an environment of 20° C.) is applied to the above-mentioned equation (2). In the following equation (4), an output potential Vout2(m) that is output from each partial temperature detection region PA of the temperature detection device 10 under a second temperature TPA2 environment (to be specific, for example, in an environment of 60° C.) differing from the first temperature TPA1 is applied to the above-mentioned equation (2).

TPA1(m)=[Rref/{(Vin/Vout1(m))−1}]×a(m)+b(m) (3)

TPA2(m)=[Rref/{(Vin/Vout2(m))−1)}]×a(m)+b(m) (4)

First, the control device 100 starts processing of detecting the output potentials Vout1(m) that are output from the respective partial temperature detection regions PA of the temperature detection device 10 under the first temperature TPA1 environment (step S1).

The power supply circuit 120 of the control device 100 supplies the input potential Vin to the sensor unit 40 of the temperature detection device 10 (step S201).

The control device 100 detects the output potential Vout1(m) output from the sensor unit 40 of the temperature detection device 10 (step 5202) and temporarily stores the output potential Vout1(m) in the RAM 88 of the control circuit 110, for example (step S203).

The control device 100 determines whether the output potentials Vout1(m) corresponding to all of the partial temperature detection regions PA in the temperature detection region SA are stored (step S204). When the output potentials Vout1(m) corresponding to all of the partial temperature detection regions PA in the temperature detection region SA are not stored (No at step S204), the control device 100 repeats the pieces of processing at step S202 to step S204 until the output potentials Vout1(m) corresponding to all of the partial temperature detection regions PA in the temperature detection region SA are stored (Yes at step S204).

When the output potentials Vout1(m) corresponding to all of the partial temperature detection regions PA in the temperature detection region SA are stored, the control device 100 subsequently starts processing of detecting the output potentials Vout2(m) that are output from the respective partial temperature detection regions PA of the temperature detection device 10 under the second temperature TPA2 environment (step S2).

The power supply circuit 120 of the control device 100 supplies the input potential Vin to the sensor unit 40 of the temperature detection device 10 (step S301).

The control device 100 detects the output potential Vout2(m) output from the sensor unit 40 of the temperature detection device 10 (step S302) and temporarily stores the output potential Vout2(m) in the RAM 88 of the control circuit 110, for example (step S303).

The control device 100 determines whether the output potentials Vout2(m) corresponding to all of the partial temperature detection regions PA in the temperature detection region SA are stored (step S304). When the output potentials Vout2(m) corresponding to all of the partial temperature detection regions PA in the temperature detection region SA are not stored (No at step S304), the control device 100 repeats the pieces of processing at step S302 to step S304 until the output potentials Vout2(m) corresponding to all of the partial temperature detection regions PA in the temperature detection region SA are stored (Yes at step S304).

When the output potentials Vout2(m) corresponding to all of the partial temperature detection regions PA in the temperature detection region SA are stored, the control device 100 subsequently starts processing of calculating the first coefficients a(m) and the second coefficients b(m) corresponding to the respective temperature detection resistor elements ER(m) (step S3).

The control device 100 reads out the output potential Vout1(m) and the output potential Vout2(m) (step S401), calculates the first coefficient a(m) and the second coefficient b(m) corresponding to the temperature detection resistor element ER(m) using the above-mentioned equation (3) and the above-mentioned equation (4) (step S402), and temporarily stores the first coefficient a(m) and the second coefficient b(m) in the RAM 88 of the control circuit 110, for example (step S403).

The control device 100 determines whether the first coefficients a(m) and the second coefficients b(m) corresponding to all of the partial temperature detection regions PA in the temperature detection region SA are stored (step S404). When the first coefficients a(m) and the second coefficients b(m) corresponding to all of the partial temperature detection regions PA in the temperature detection region SA are not stored (No at step S404), the control device 100 repeats the pieces of processing at step S401 to step S404 until the first coefficients a(m) and the second coefficients b(m) corresponding to all of the partial temperature detection regions PA in the temperature detection region SA are stored (Yes at step S404).

When the first coefficients a(m) and the second coefficients b(m) corresponding to all of the partial temperature detection regions PA in the temperature detection region SA are stored, the control device 100 stores, in the storage unit 50 of the temperature detection device 10, the first coefficients a(m) and the second coefficients b(m) corresponding to the respective temperature detection regions PA as the pieces of unique information illustrated in FIG. 6 (step S405).

Subsequently, the control device 100 starts processing of checking consistency of the pieces of unique information (step S4).

The control device 100 reads out the pieces of unique information stored in the storage unit 50 (step S501) and determines whether the pieces of read unique information are normal (step S502). When the pieces of read unique information are normal (Yes at step S502), the processing of deriving the pieces of unique information is ended. When the pieces of read unique information are not normal (No at step S502), the control device 100 returns to step S1 and repeats the above-mentioned processing of deriving the pieces of unique information. In the processing of checking the consistency of the pieces of unique information from step S4, a mode in which whether pieces of data of the first coefficients a(m) and the second coefficients b(m) temporarily stored in the RAM 88 of the control circuit 110 and pieces of data of the first coefficients a(m) and the second coefficients b(m) as the pieces of unique information stored in the storage unit 50 match with each other is determined may be employed. The present disclosure is not limited by the method of checking the consistency of the pieces of unique information stored in the storage unit 50.

As described above, in the present disclosure, the temperature detection device 10 according to the first embodiment includes the storage unit 50 configured to store therein the first coefficients a(m) and the second coefficients b(m) corresponding to the output potentials Vout(m) that are output from the respective temperature sensors SENS(m) as the pieces of unique information for the respective temperature detection resistor elements ER(m) provided in the corresponding partial temperature detection regions PA, and the external control device 100 reads out the pieces of unique information stored in the storage unit 50 to perform the temperature detection processing for the respective partial temperature detection regions PA in the temperature detection region SA in the temperature detection device 10. Increase in cost due to provision of the temperature detection function in the HUD device 1 can thereby be prevented.

The temperature detection device 10 according to the first embodiment can appropriately change and update the pieces of unique information stored in the storage unit 50 because the storage unit 50 configured by, for example, the non-volatile memory can be rewritten. Flexible approach such as rewriting of the pieces of unique information by the control device 100 can therefore be performed as described above when the pieces of unique information need to be changed or updated after shipping of the temperature detection device 10.

It is sufficient that the temperature detection device 10 according to the first embodiment supplies power supply to the input potential Vin, the non-volatile memory configuring the storage unit 50, and the like from the control device 100 when the temperature detection processing is performed. Power consumption can thus be reduced in comparison with that when a circuit corresponding to the control circuit 110 is mounted on a temperature detection device. The control circuit 110 can enhance accuracy of the necessary output potentials Vout(m) in the temperature detection processing by understanding the input potential Vin that is supplied from the power supply circuit 120.

The temperature detection device 10 according to the first embodiment includes no circuit corresponding to the control circuit 110 that performs the temperature detection processing. Accordingly, the temperature detection device 10 is not necessarily required when a temperature detection processing computer program is changed or updated, and the temperature detection processing computer program can be changed or updated only by the control device 100.

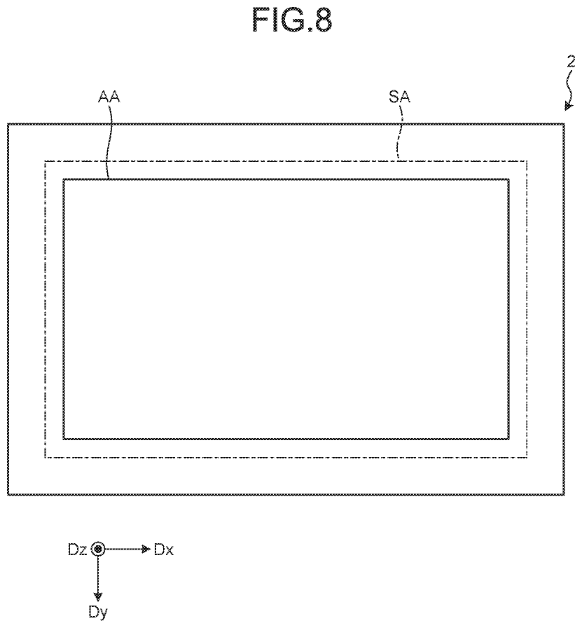

FIG. 8 is a plan view for explaining a positional relation between the display region and the temperature detection region in the display panel. As illustrated in FIG. 8, since the temperature detection device 10 and the display panel 2 overlap with each other in the third direction Dz such that the temperature detection region SA covers the display region AA of an image by the display panel 2, the temperature detection device 10 can detect temperature change that is possibly caused by light guided by the optical system RM and condensed toward the display region AA of the display panel 2. Operation control of the display panel 2 in accordance with the temperature change can thereby be performed. When the temperature detection device 10 detects such high temperature that display output quality of the display panel 2 cannot be ensured, operations of the display panel 2 may be stopped. In such a case, display output of an image by the display panel 2 may be stopped only in a range corresponding to a part (partial temperature detection region PA) of the temperature detection device 10 at which the high temperature has been detected.

The temperature detection device 10 does not have to be provided in the HUD device 1. For example, the temperature detection device 10 may be provided so as to overlap with a display device in another mode, the temperature detection device 10 may be combined with a device other than the display device, or the temperature detection device 10 may be provided alone.

### Second Embodiment

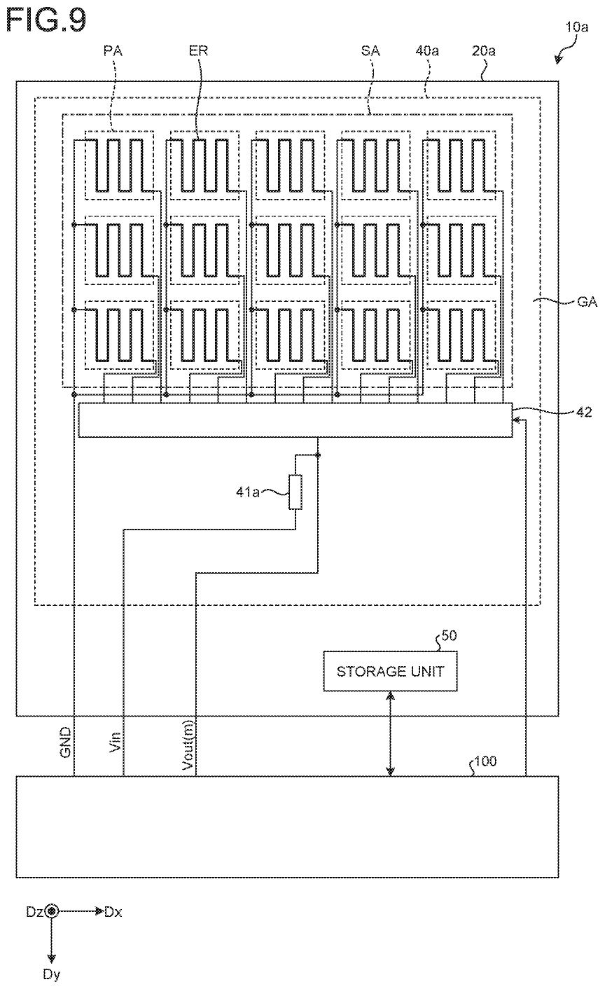

FIG. 9 is a schematic view illustrating the main configuration of a temperature detection device according to a second embodiment and a control device. In the following explanation, the same reference numerals denote the same components as those described in the above-mentioned first embodiment and overlapped explanation thereof is omitted. Only different points from the first embodiment will be explained.

In a temperature detection device 10a according to the second embodiment illustrated in FIG. 9, a sensor unit 40a includes a multiplexer 42.

The multiplexer 42 is a switch circuit configured to couple any one of the temperature detection resistor elements ER(m) and the control device 100. The multiplexer 42 selects the temperature detection resistor element ER(m) that is electrically coupled to the control device 100 among the temperature detection resistor elements ER(m). In the present embodiment, the multiplexer 42 is configured by a logic IC provided in the peripheral region GA of a sensor base member 20a. The multiplexer 42 selects the temperature detection resistor element ER(m) to be coupled to the control device 100 with a control signal that is output from the GPIO 89 of the control circuit 110 provided in the control device 100, for example. The temperature sensor SENS(m) illustrated in FIG. 3 is configured by electrically coupling the temperature detection resistor element ER(m) selected by the multiplexer 42 and a reference resistor element 41a in series. With this configuration, the number of wiring lines between the temperature detection device 10a and the control device 100 can be largely reduced.

Modification

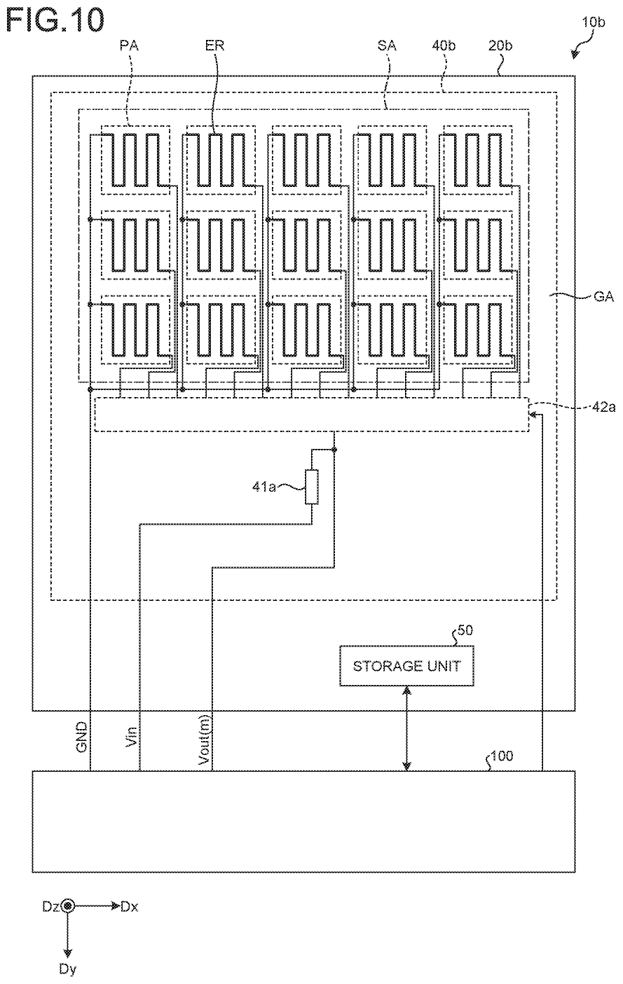

FIG. 10 is a schematic view illustrating the main configuration of a temperature detection device according to a modification of the second embodiment and a control device. In a temperature detection device 10b according to the modification illustrated in FIG. 10, a multiplexer 42a of a sensor unit 40b is configured by a thin film transistor (TFT) switch circuit provided in the peripheral region GA of a sensor base member 20b unlike the multiplexer 42 configured by the logic IC in the second embodiment. This configuration can contribute to reduction in cost in comparison with the configuration in the second embodiment.

The components in the above-mentioned embodiments can be appropriately combined. Other action effects provided by the modes described in the present embodiments that are obvious from description of the present specification or at which those skilled in the art can appropriately arrive should be interpreted to be provided by the present disclosure.

What is claimed is:

1. A temperature detection device comprising:
a plurality of temperature sensors each including a temperature detection resistor element provided in a temperature detection region; and
a storage unit configured to store therein unique information for each of a plurality of the temperature detection resistor elements, wherein
the temperature detection resistor element is provided for each of a plurality of partial temperature detection regions in the temperature detection region, and
an externally provided control device reads out the unique information stored in the storage unit and detects a temperature for each of the partial temperature detection regions in the temperature detection region based on the unique information and an output potential that is output from the temperature sensor.

2. The temperature detection device according to claim 1, wherein
in each of the temperature sensors,
the temperature detection resistor element and a reference resistor element provided in a peripheral region outside the temperature detection region are electrically coupled in series, and
a potential at a coupling point between the reference resistor element and the temperature detection resistor element is output as the output potential.

3. The temperature detection device according to claim 2, wherein the unique information contains a predetermined coefficient differing for each of the temperature detection resistor elements.

4. The temperature detection device according to claim 3, wherein where a resistance value of the reference resistor element is Rref, an input potential of the temperature sensor is Vin, the output potential is Vout, a first coefficient contained in the unique information is a, and a second coefficient contained in the unique information is b, a temperature TPA that is detected for each of the partial temperature detection regions is expressed by the following equation (1).
TPA=[Rref/{(Vin/Vout)−1}]×a+b (1)

5. The temperature detection device according to claim 4, wherein where an output potential of the temperature sensor at a predetermined first temperature TPA1 is Vout1 and an output potential of the temperature sensor at a second temperature TPA2 differing from the first temperature TPA1 is Vout2, the first coefficient and the second coefficient are calculated using the following equation (2) and the following equation (3).
TPA1=[Rref/{(Vin/Vout1)−1}]×a+b (2)
TPA2=[Rref/{(Vin/Vout2)−1)}]×a+b (3)

6. The temperature detection device according to claim 1, comprising a multiplexer configured to select the temperature detection resistor element that is electrically coupled to the control device among the temperature detection resistor elements.

7. The temperature detection device according to claim 6, wherein the multiplexer is configured by a logic IC.

8. The temperature detection device according to claim 6, wherein the multiplexer is a TFT switch circuit configured on a base member on which the temperature detection resistor elements are provided.

9. A temperature detection system comprising:
a temperature detection device including
a plurality of temperature sensors each including a temperature detection resistor element provided in a temperature detection region, and
a storage unit configured to store therein unique information for each of a plurality of the temperature detection resistor elements,
the temperature detection resistor element being provided in each of a plurality of partial temperature detection regions in the temperature detection region; and
a control circuit configured to read out the unique information stored in the storage unit and detect a temperature for each of the partial temperature detection regions in the temperature detection region based on the unique information and an output potential that is output from the temperature sensor.

10. The temperature detection system according to claim 9, wherein
in each of the temperature sensors,
the temperature detection resistor element and a reference resistor element provided in a peripheral region outside the temperature detection region are electrically coupled in series, and
a potential at a coupling point between the reference resistor element and the temperature detection resistor element is output as the output potential.

11. The temperature detection system according to claim 10, wherein the unique information contains a predetermined coefficient differing for each of the temperature detection resistor elements.

12. The temperature detection system to claim 11, wherein where a resistance value of the reference resistor element is Rref, an input potential of the temperature sensor is Vin, the output potential is Vout, a first coefficient contained in the unique information is a, and a second coefficient contained in the unique information is b, a temperature TPA that is detected for each of the partial temperature detection regions is expressed by the following equation (4).
TPA=[Rref/{(Vin/Vout)−1}]×a+b (4)

13. The temperature detection system according to claim 12, wherein where an output potential of the temperature sensor at a predetermined first temperature TPA1 is Vout1 and an output potential of the temperature sensor at a second temperature TPA2 differing from the first temperature TPA1 is Vout2, the first coefficient and the second coefficient are calculated using the following equation (5) and the following equation (6).
TPA1=[Rref/{(Vin/Vout1)−1}]×a+b (5)
TPA2=[Rref/{(Vin/Vout2)−1)}]×a+b (6)

14. The temperature detection system according to claim 9, comprising a multiplexer configured to select the temperature detection resistor element that is electrically coupled to the control circuit among the temperature detection resistor elements.

15. The temperature detection system according to claim 14, wherein the multiplexer is configured by a logic IC.

16. The temperature detection system according to claim 14, wherein the multiplexer is a TFT switch circuit configured on a base member on which the temperature detection resistor elements are provided.

17. A display device comprising:
a display panel configured to display an image; and
the temperature detection device according to claim 1, wherein
the temperature detection device is arranged so as to overlap with the display panel.

18. The display device according to claim 17, wherein the temperature detection region is arranged so as to overlap with a display region in which an image is displayed on the display panel.

19. A head-up display comprising:
a display panel configured to display an image; and
a temperature detection device arranged so as to overlap with a display surface of the display panel, wherein
the temperature detection device includes
a plurality of temperature sensors each including a temperature detection resistor element provided in a temperature detection region, and
a storage unit configured to store therein unique information for each of a plurality of the temperature detection resistor elements,
the temperature detection resistor element is provided for each of a plurality of partial temperature detection regions in the temperature detection region, and
an externally provided control device reads out the unique information stored in the storage unit and detects a temperature for each of the partial temperature detection regions in the temperature detection region based on the unique information and an output potential that is output from the temperature sensor.
